(19) United States
(12) Patent Application Publication
(10) Pub. No.: US 2026/0052365 A1
(43) Pub. Date: Feb. 19, 2026

(54) TEXT TRIGGERED EMERGENCY LOCATION TRANSMISSION

(71) Applicant: T-Mobile Innovations LLC, Overland Park, KS (US)

(72) Inventor: Hang Hoi YAU, Sammamish, WA (US)

(21) Appl. No.: 18/804,552

(22) Filed: Aug. 14, 2024

(51) Int. Cl. H04W 4/90; H04W 4/029; H04W 4/12

(52) U.S. Cl. CPC H04W 4/90; H04W 4/029; H04W 4/12

(57) ABSTRACT

Systems, methods and devices are provided for transmitting, by a wireless device, a text message to a public safety answering point (PSAP) using a wireless network, receiving a location request from the PSAP using the wireless network and, in response to the receiving the location request, transmitting a location response comprising a wireless device location to the PSAP using the wireless network.

### TECHNICAL BACKGROUND

In some emergency situations, a voice call to emergency services might not be completed, or a person may be in a situation, such as an active shooter emergency, where a voice call might not be possible. In those situations, a person may still be able to send a text message to emergency operators, as many modern public safety answering points (PSAPs) are capable of receiving messages in multiple formats. However, often if the person does not provide information regarding their location, help might take too long to arrive.

### OVERVIEW

Exemplary embodiments described herein include systems, methods, and processing nodes for emergency wireless device location transmission. An exemplary method includes transmitting, by a wireless device, a text message to a public safety answering point (PSAP) using a wireless network. Based on the transmission using the wireless network, the method includes receiving a location request from the PSAP using the wireless network. The method further includes, in response to receiving the location request, transmitting a location response including a wireless device location to the PSAP using the wireless network.

Further exemplary embodiments include a system for emergency wireless device location transmission. The system includes a wireless network. The system additionally includes a computing device including a processor configured to transmit a text message to a PSAP using the wireless network. The processor is further configured to receive a location request from the PSAP using the wireless network using the wireless network and, in response to receiving the location request, transmit a location response including a wireless device location to the PSAP using the wireless network.

In yet a further exemplary embodiment, a non-transitory computer readable medium is provided. The non-transitory computer-readable medium stores instructions, when executed by a processor, configuring the processor to transmit a call request to a PSAP using a wireless network, determine a connection status based on the wireless network, and, in response to the connection status, transmit a SMS message to the PSAP using the wireless network.

### BRIEF DESCRIPTION OF THE DRAWINGS

FIG. 1 illustrates an exemplary system for transmitting a text message and receiving a location request in accordance with discloses embodiments.

FIG. 2A is a block diagram illustrating an exemplary system in state of sending a text message and receiving a location request by a wireless device, in accordance with disclosed embodiments.

FIG. 2B is a block diagram illustrating the exemplary system of FIG. 2A in a state of sending a location response by the wireless device, in accordance with disclosed embodiments.

FIG. 3 illustrates an exemplary time series of a location request based on an SMS emergency transmission in accordance with disclosed embodiments.

FIG. 4 illustrates an exemplary method for SMS emergency contact in accordance with disclosed embodiments.

FIG. 5 illustrates an example of a processing node in accordance with aspects of this disclosure.

FIG. 6 illustrates an example of a computing device in accordance with aspects of this disclosure.

### DETAILED DESCRIPTION

In those situations where a voice call cannot be completed, or the situation renders placing the voice call unfeasible or unadvisable, a person may still be able to send a text message, such as an SMS message, to emergency services. During the emergency, a person may be unable to provide their location through the body of the text message. For example, the person may be in a position where he or she can only send a text message without any content. In instances such as the ones described, emergency services may still be able to locate the device even when the person cannot provide that information.

As many modern public safety answering points (PSAPs) are capable of receiving and sending requests using a plurality of mediums, a PSAP may be able to request an accurate location for the device without further need for participation from the person with the ongoing emergency.

Exemplary embodiments described herein include methods and systems for providing a device location based on a text message trigger to an emergency service, such as a PSAP. For example, after the device transmits an emergency text message, a PSAP may send a request from location to the device over a data layer of communication.

Emergencies described herein may include a combination of multiple types of events, such as active shooting, vehicular crashes, ongoing robberies, kidnappings, dangerous encounters with wildlife, and many other emergencies. Although any type of emergency may be included, the ability to send a text message without placing a voice call may be particularly important in situations where it is vital that the person is not noticed or makes as little sound as possible. For example, in an active shooter situation, staying hidden is crucial to the safety of the individual contacting emergency services.

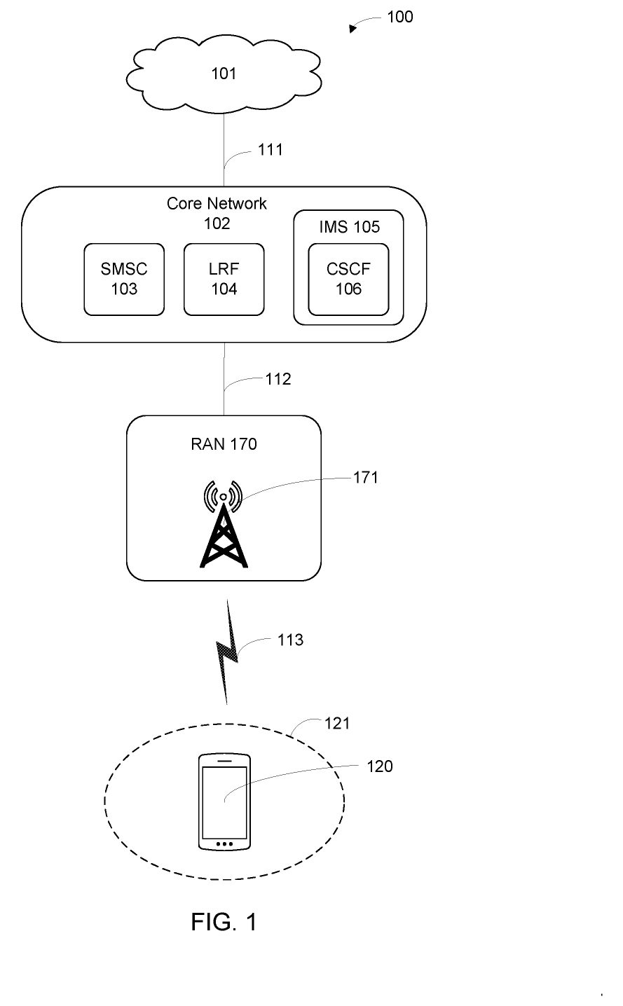

These and other examples will be described in greater detail below in relation to FIGS. 1-6.

FIG. 1 depicts an exemplary system 100 for text message communication. System 100 includes a communication network 101, a core network 102 and a radio access network (RAN) 170, including at least one access node 171.

Core network 102 is connected to communication network 101 over communication link 111. Core network 102 includes a short message service center (SMSC) 103. SMSC 103 as used herein is an SMS management component used for storing, forwarding, and delivering SMS messages. It should be noted that only SMSC 103 is described for ease of description, and that core network 102 may further include other components used for handling text messages, such as such as a multimedia messaging service center (MMSC).

Core network includes a location retrieval function (LRF) component 104. LRF 104 as used herein is a location retrieval component used for retrieving raw location data from a device, converting the raw location data into standard formats, and providing the formatted data to networks, such as network 101. In embodiments, LRF 104 may convert the raw location data into a Presence Information Data Format - Location Object (PIDF-LO). In embodiments, LRF 104 may convert the raw location data into a session initiation protocol (SIP) format.

Core network 102 also includes an IP multimedia subsystem (IMS) 105. IMS 105 as used herein is a framework used for delivering IP multimedia services, such as rich communication services (RCS), across a network. IMS 105 includes a call session control function (CSCF) 106. CSCF 106 as used herein is a component of IMS 105 used for session control, signaling and routing in multimedia communication. In embodiments, CSCF 106 is used for handling SIP communication. In embodiments, IMS 105 may be used for communication between entities or components of network 101 and wireless device 120. For example, CSCF 106 may be used for transmitting SIP communication to wireless device 120.

The RAN 170 may include other devices and additional nodes not described herein. For example, RAN 170 may include devices used for forwarding SMS messages from wireless device 120 to core network 102. In some embodiments, RAN 170 may include devices used for forwarding device location data from wireless device 120 to core network 102.

RAN 170 is connected to core network 102 over communication link 112.

System 100 also includes a wireless device 120. In embodiments, system 100 may include multiple wireless devices. Wireless device 120 is configured to operate in one or more coverage areas 121. Wireless device 120 may be an end-user wireless device. Wireless device 120 may include any device configured to send and receive SMS messages, messages over SIP, and location data. For example, wireless device 120 may include location components, such as GPS, which are used for sending a location of the wireless device 120 to an entity, or component, within network 101 through RAN 170 and core network 102. In embodiments, wireless device 120 communicates with RAN 170 over communication link 113. Examples of communication link 113 may include 5G network, 4G LTE, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless device 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may have an evolved packet core (EPC) or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although one core network 102 is shown, multiple core networks 102 may be utilized. Alternatively, the single core network 102 may include a distributed, cloud-native, converged core gateway. Thus, the converged core gateway could connect a 4G LTE evolved packet core (EPC) to a 5G core network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access node 171. The RAN 170 is disposed between the core network 102 and the end-user wireless devices 120. Components of the RAN 170 may communicate directly with the core network 102 and others may communicate directly with the end user wireless devices 120. The RAN 170 may provide services from the core networks 102 to the end-user wireless devices 120.

The RAN 170 includes at least an access node (or base station) 171 such as an eNodeB or gNodeB communicating with the plurality of end-user wireless devices 120. In embodiments, access node 171 includes a unique identifier. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access node 171 can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs).

In additional embodiments, access nodes may comprise two co-located cells, or antenna/transceiver combinations that are mounted on the same structure. Alternatively, access node 171 may comprise a short range, low power, small-cell access node such as a microcell access node, a picocell access node, a femtocell access node, or a home eNodeB device. As will be further described below, functionality for emergency navigational pathing may be included within the access nodes.Access node 171 can be configured to deploy one or more different carriers, utilizing one or more RATs. For example, a gNodeB may support NR and an eNodeB may provide LTE coverage. It would be evident to one of ordinary skill in the art, in light of this disclosure, the many other combinations of access nodes and carriers that could be deployed.

The access nodes 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with an access node. The term “wireless device” may also include an end-user wireless device, which may communicate with the access node 171 through the relay node. The term “wireless device” may further include an end-user wireless device that communicates with the access node 171 directly without being relayed by a relay node.

Wireless devices 120 may be any device, system, combination of devices, or other such communication platform capable of communicating wirelessly with access network 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless devices 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for emergency wireless device location transmission may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

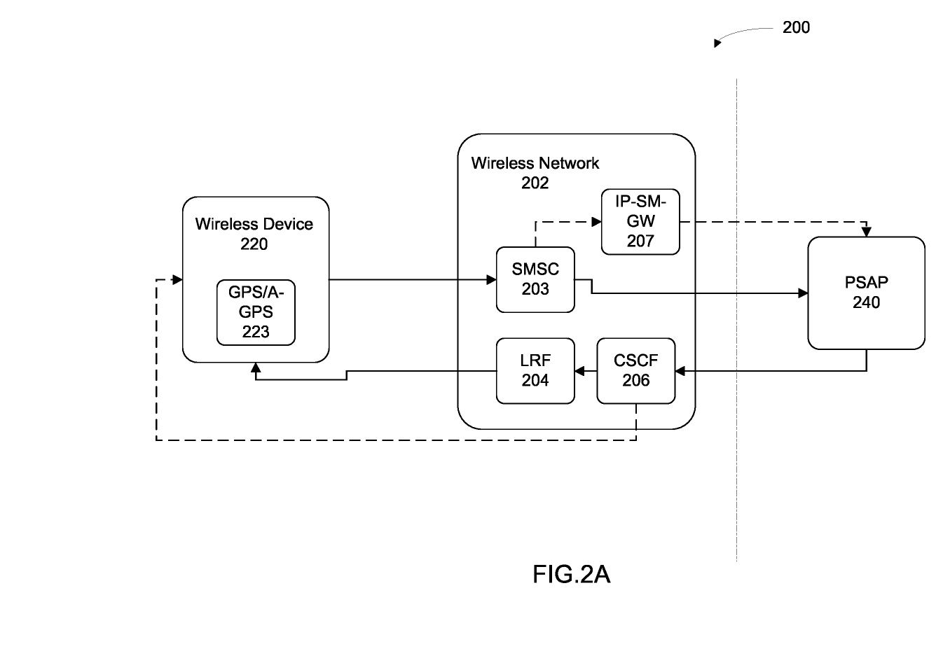

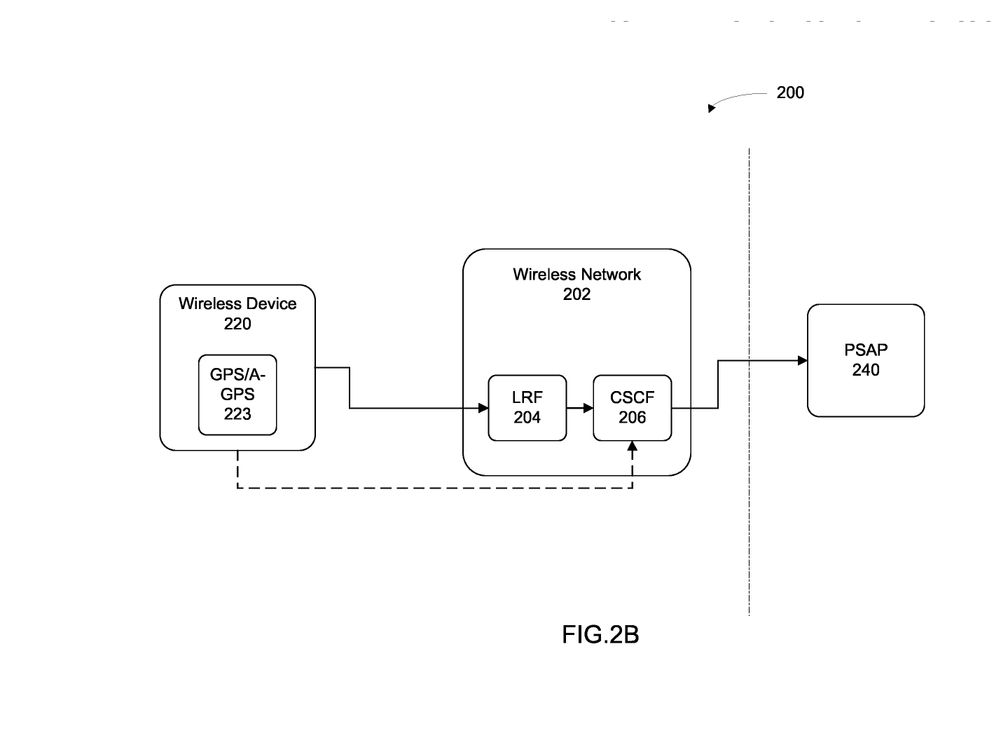

Now referring to FIGS. 2A-2B, an exemplary system 200 for requesting a wireless device location based on a text message trigger is presented. System 200 includes a wireless device 220. Wireless device 220 may be the same as wireless device 120. System 200 also includes wireless network 202. Wireless network 202 may include a RAN, core network and/or a communication network, which may be the same as, respectively, RAN 170, core network 102 and communication network 101. Wireless network 202 includes services and components used by a wireless network for handling text and data transmission to emergency services. For example, wireless network 202 may include base transceiver station traffic channels (TCH), packet data channels (PDCH) and control channels (CCH) used for transmitting. Wireless network 202 also includes SMSC 203, LRF 204 and CSCF 206, which may be the same as, respectively, SMSC 103, LRF 104 and CSCF 106. It should be noted that SMSC 203, LRF 204 and CSCF 206 are provided as examples for ease of description. As such, system 200 may include other components for performing the steps described, which are not described herein. For example, a MMSC may be used for transmitting the triggering text message.

The system 200 also includes a public safety answering point (PSAP) 240. The PSAP 240 may include any emergency answering service capable of receiving multimedia messages including text messages, such as SMS messages, and messages using SIP. Wireless Network 202 connects to PSAP 240 through a communication link. The communication link may include communication link 111 described in reference to FIG. 1. PSAP 240 may be equipped with a Next Generation 911 (NG911) system capable of receiving text, video and data in a plurality of formats. In embodiments, PSAP 240 and wireless network 202 may be configured to communicate over an emergency services IP network (ESInet). In some embodiments, PSAP 240 and wireless network 202 may be configured to communicate using an IP multimedia subsystem (IMS). It is noted that PSAP 240 and wireless networks 202 may communicate over other network architectures not described herein.

The wireless device 220 includes a GPS/A-GPS 223 components. As used herein, GPS/A-GPS 223 refers to global positioning system (GPS) and Assisted GPS (A-GPS), which uses cellular network information in conjunction with GPS data, used for gathering accurate location from a wireless device. Although GPS/A-GPS 223 are used in this nonlimiting example, system 200 may include many other components used for gathering device location, such as Wi-Fi based components, cell tower triangulation, Cell ID and the like, which may be used on their own or in conjunction with GPS/A-GPS 223 for determining accurate location for wireless device 220.

In some embodiments, wireless network 202 may include an IP short message gateway (IP-SM-GW) 207. As used herein, the IP-SM-GW 207 is a component of IMS used for transmitting text messages of IP networks.

Referring to FIG. 2A, wireless device 220 is configured to transmit a text message to PSAP 240. In this example, SMSC 203 is used for handling the text message transmission. In some embodiments, components of IMS may be used for transmitting the text message. For example, shown in dashed arrow lines, the text message may be transmitted using IP-SM-GW 207. This example is described using SMSC 203. However, it should be noted, as described above, other components such as a MMSC may be used for handling the text message transmission.

Once the text message is transmitted to the PSAP 240, the wireless device may be configured to start a timer as to give the wireless network 202 and/or PSAP 240 time to handle the transmission. As a result of the text message transmission, wireless network is configured to receive a location request by the PSAP 240 for the wireless device 220. Once the timer expires, wireless device 220 may be configured to reject location requests. In this example, the request is transmitted in a SIP format. It should be noted that wireless network 202 and/or wireless device 220 may be configured to handle the location request in other formats not described herein.

In this example, wireless network 202 uses CSCF 206 to receive the SIP location request. CSCF 206 is configured to receive the SIP location request, such as an SIP INFO request including an identifier for the wireless device, and routes to an appropriate component based on the request. In this example, the SIP INFO request includes a location request. Once CSCF 206 identifies the location request, the SIP request is routed to the LRF 204. For example, CSCF 206 transmits a location query to LRF 204 that includes the request and relevant identifiers such as an identifier for the wireless device 220 and the request session. In some embodiments, although yielding less accurate location responses, the CSCF 206 may route the SIP location request directly to the wireless device 220, shown dashed arrow lines.

Continuing with FIG. 2A, once routed to the LRF 204, the LRF 204 is configured to send a location query to the wireless device 220. In this example, LRF 204 transmits the location request to the wireless device 220. However, it should be noted that LRF 204 may additionally perform network-based methods for gathering a location for the wireless device 220, such as Wi-Fi positions, cell tower triangulation methods, querying location databases for that device, and the like.

Now referring to FIG. 2B, once the wireless device 220 receives the SIP location request from the LRF 204, wireless device 220 is configured to determine its location using one or more of its internal location components. In this example, wireless device 220 uses GPS/A-GPS 223 for determining the location of the wireless device 220 due to their high degree of accuracy. However, as noted above, other components and methods may be used for determining the location of wireless device 220. For example, in an emergency situation occurring in a dense urban area, wireless device 220 may use Wi-Fi Positioning system (WPS) for determining its location due to the presence of multiple Wi-Fi networks near the device.

Once the device location is determined, wireless device 220 is configured to transmit the device location to the LRF 204. In some embodiments, LRF 204 may be used to decode the raw location data and format it into an SIP response. For example, the LRF 204 may format the raw location into an SIP format with a geological-routing header, such PIDF-LO format. In some embodiments, wireless device 220 may be configured to transmit the location response into an SIP format. In embodiments, wireless device 220 may transmit a location response as a SIP message with a geolocation-routing header, such as PIDF-LO format. In some embodiments, wireless device 220 may transmit the location response using a SIP PUBLISH method. By using SIP PUBLISH, the CSCF 206 may transmit a notification to PSAP 240 that the location response was received.

In this example, the wireless device 220 may be configured to transmit raw location or SIP formatted location response to LRF 204. If raw location is sent, LRF 204 decodes and formats the response prior to sending the response to CSCF 206. If the response is already formatted by wireless device 220, LRF 204 only redirects the formatted location response to CSCF 206.

It should be noted that in configurations where the SIP location request is routed directly to wireless device 220 by CSCF 206, wireless device 220 may send a formatted location response to CSCF 206, shown is dashed arrow lines in FIG. 2B. Once CSCF 206 receives the location response, wither from LRF 204 or directly from wireless device 220, CSCF 206 routes the location response to the PSAP 240. As mentioned throughout this disclosure, once PSAP 240 receives the location response, emergency services may be able to locate the device and provide assistance.

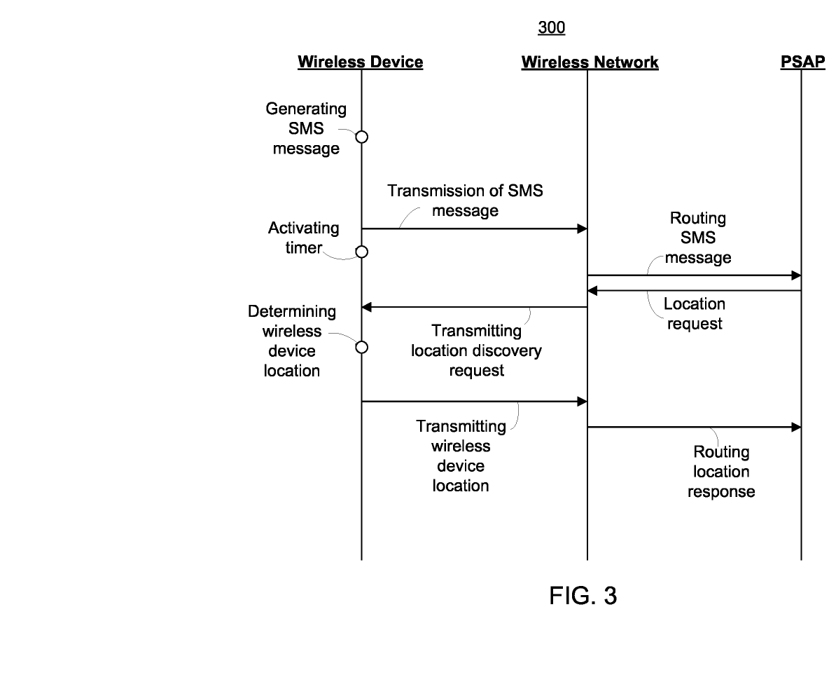

Now referring to FIG. 3, an example time series flow 300 is presented. In this example, the flow begins with a wireless device generating an SMS message. As noted above, SMS message is used as an example for ease of description, and other text message formats may be used. The flow proceeds by the transmission of the SMS message, from the wireless device to the wireless network. Once the wireless network receives the SMS message, the flow continues by the routing of the SMS message to the PSAP. For example, the wireless network may use base station id, in conjunction with home location registers (HLR) and/or home subscriber servers (HSS) for identifying PSAP to route the text message.

Once the PSAP receives the SMS message, the flow proceeds by a location request for the wireless device being sent to the wireless network. Once the request is received by the wireless network, the flow continues by transmitting a location discovery request from the wireless network to the wireless device. In embodiments, the location discovery request may be in a SIP format. In embodiments, the wireless device may activate a timer after transmitting the SMS message to allow time for the PSAP to receive the transmission and send a request for location. Once the timer expires, the wireless device may reject the location discovery request.

Once the location discovery request is received by the wireless device, the flow continues by determining wireless device location by the wireless device. As described in reference to FIGS. 2A-2B, wireless device may determine its device location using a plurality of components, such as GPS, cellular data, wi-fi positioning, and the like. Once the device location is determined, the flow continues by transmitting the wireless device location to the wireless network. As mentioned above, the wireless device may transmit the device location through LRF and CSCF, or directly through CSCF, depending on whether the response is formatted by the wireless device. As mentioned in reference to FIGS. 2A-2B, the wireless network may provide additional location information using location methods, such as cell tower triangulation, cell ID, and the like.

Once the wireless device location is received by the wireless network, the flow is finalized by routing the wireless device location to the PSAP. As described in reference to FIGS. 2A-2B, the wireless device location may be sent using SIP. In some embodiments, the wireless device location may be in a PIDF-LO. Once the flow is completed, PSAP may be able to locate the wireless device and send assistance to the location.

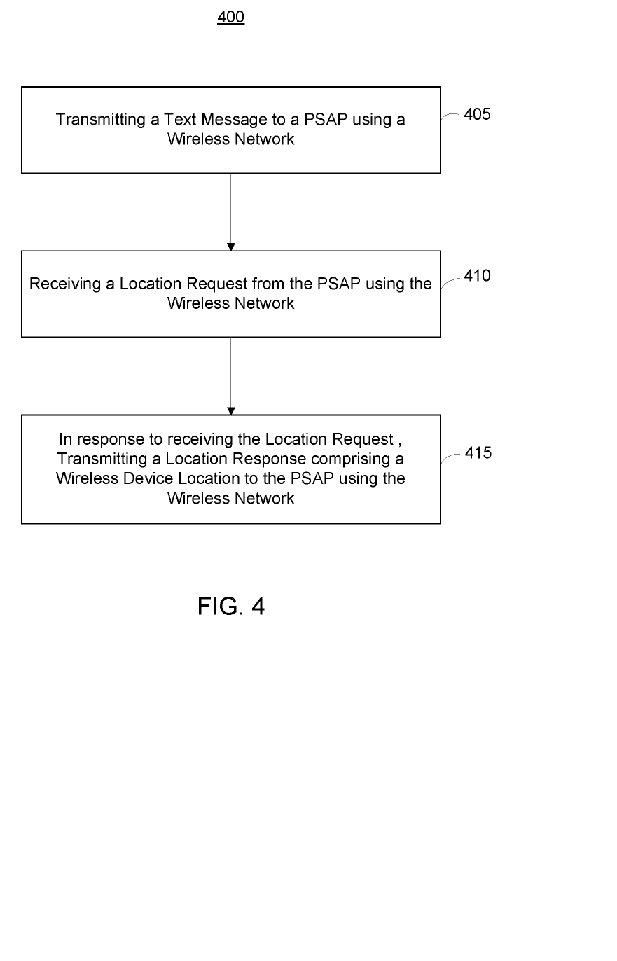

Now referring to FIG. 4, an example flow diagram of a method 400 for transmitting a wireless device location is presented. At step 405, method 400 includes transmitting a text message to a PSAP using a wireless network, such as wireless network 202 and PSAP 240.

In embodiments, method 400 may include activating a timer after transmitting the text message to allow the location request from the PSAP to be completed.

The method 400, at step 410, includes receiving a location request from the PSAP using the wireless network. In embodiments, the location request may be a SIP request.

At step 415, method 400 includes, in response to receiving the location request, transmitting a location response comprising a wireless device location to the PSAP using the wireless network. In embodiments, the location response may be a SIP response. In some embodiments, method 400 may further include adding a geolocation-routing header to the location response. In embodiments, the location response may be in a PIDF-LO format.

In some embodiments, method 400 may include determining the wireless device location. In embodiments, determining the wireless device location may include using a GPS. In some embodiments, determining the wireless device location may include using an A-GPS. In some embodiments, determining the wireless device location may include using an identifier for the base station connected to the wireless device, such as Cell ID method. In some embodiments, determining the wireless device location may include using cell tower triangulation.

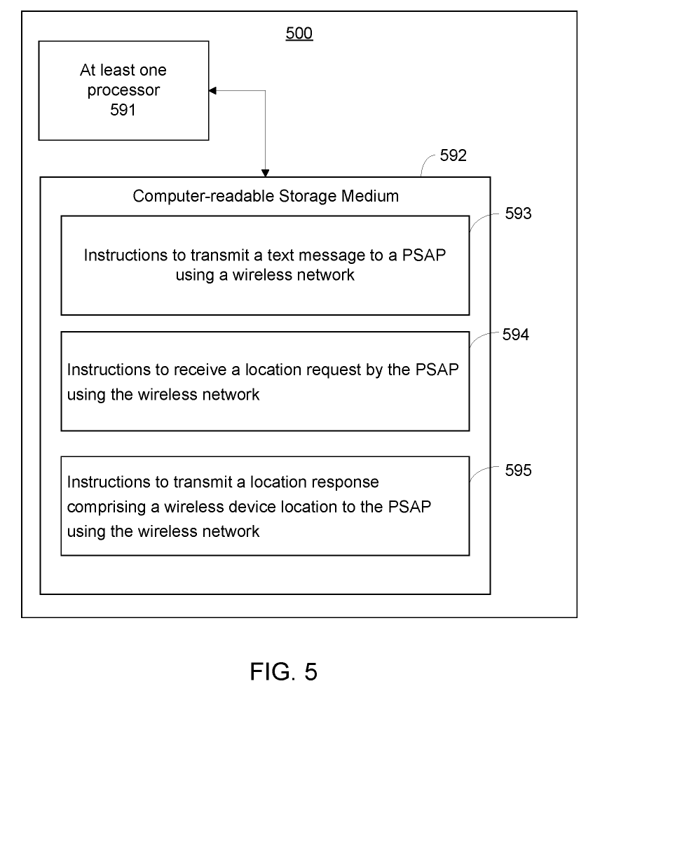

Now referring to FIG. 5, an example computing device 500 is presented. In this example, computing device 500 includes at least one processor 591 communicably coupled to a computer-readable storage medium 592. The at least one processor 591 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 592. In instances, at least one processor 591 may include electronic circuitry for performing instructions described in this disclosure.

In instances, computer-readable storage medium 592 may be any medium suitable for storing executable instructions. In examples, without limitation, computer-readable storage medium 592 may include RAM, ROM, EEPROM, HHD, SSD, optical disc, and the like. Computer-readable medium storage 592 may be disposed within computing device 500. In embodiments, computer-readable storage medium 592 may external, and communicably connected, to computing device 500. The instruction stored on computer-readable storage medium may be used to implement method steps described in reference to FIG. 4.

In this example, computer-readable storage medium 592 is encoded with set of instructions 593-595. In embodiments, executable instructions included in each block may be included in different blocks shown and blocks not shown.

Instruction 593, when executed by at least one processor 591, configures the at least one processor 591 to transmit a text message to a PSAP using a wireless network.

Instruction 594, when executed by at least one processor 591, configures the at least one processor 591 to receive a location request by the PSAP using the wireless network. The wireless network may be consistent with, or include, network components described in reference to FIGS. 1, 2A and 2B, such as wireless network 202.

Instruction 595, when executed by at least one processor 591, configures the at least one processor 591 to, in response to receiving the location request, transmit a location response comprising a wireless device location to the PSAP using the wireless network. In embodiments, the least one processor may be configured to determine the wireless device location. The PSAP may include PSAP 240 described in reference to FIGS. 2a-2b.

In embodiments, the at least one processor 591 may be configured to transmit the location response using a session initiation protocol (SIP). In some embodiments, the at least one processor 591 may be configured to transmit the location response in a presence information data format – location object (PIDF-LO) format.

The computer-readable storage medium 592 may be further encoded with instructions, when executed by the at least one processor 591, configuring the at least a processor 591 to activate a timer after transmitting the SMS message to allow the location request from the PSAP.

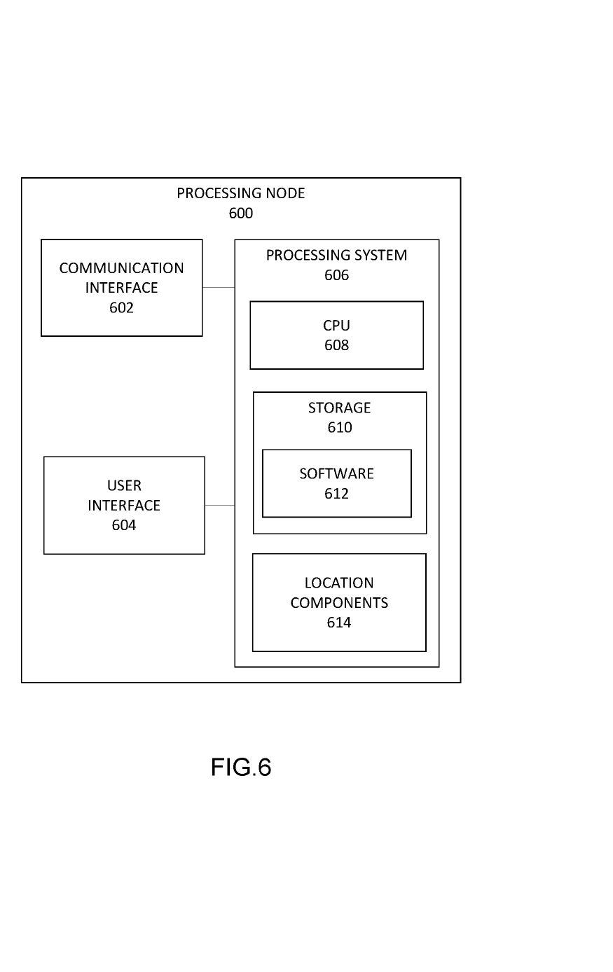

Now referring to FIG. 6, an example processing node 600, which may be configured to perform the methods and operations disclosed herein for selective attestation for emergency calls. The processing node 600 includes a communication interface 602, user interface 604, and processing system 606 in communication with communication interface 602 and user interface 604. Communication interface 602 may include hardware components, such as network communication ports, devices, routers, wires, antenna, transceivers, etc. User interface 604 may include hardware components, such as touch screens, buttons, displays, speakers, etc.

Processing system 606 includes a central processing unit (CPU) or processor 608, storage 610 and location components 614. Storage 610 may include a disk drive, flash drive, memory circuitry, or other memory device including, for example, a buffer. Storage 610 can store software 612 which is used in the operation of the processing node 600. Software 612 may include computer programs, firmware, or some other form of machine-readable instructions, including an operating system, utilities, drivers, network interfaces, applications, or some other type of software. Processing system 606 may include a processor 608 and other circuitry to retrieve and execute software 612 from storage 610, which may be internal or external to the processing system 606. Location components 614 may include GPS receiver, cellular radio, wi-fi module, Bluetooth module, and the like. In examples, software 612 may include computer programs used for gathering location from location components 614, such as operating system location services, assisted GPS (A-GPS), network-based positions, and the like. Processing node 600 may further include other components such as a power management unit, a control interface unit, etc., which are omitted for clarity. Communication interface 602 permits processing node 600 to communicate with other network elements. User interface 604 permits the configuration and control of the operation of processing node 600. Processing node 600 may be included in various elements of the wireless network including an access node, P-CSCF, E-CSCF, GMLC, STI-AS, SBC, or PSAP for example. In this example, software 612 may include the instructions described in reference to FIG. 5.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
transmitting, by a wireless device, a text message to a public safety answering point (PSAP) using a wireless network;
receiving a location request from the PSAP using the wireless network; and
in response to receiving the location request, transmitting a location response comprising a wireless device location to the PSAP using the wireless network.

2. The method of claim 1, further comprising activating a timer after transmitting the text message to allow the location request from the PSAP.

3. The method of claim 1, further comprising determining the wireless device location.

4. The method of claim 3, wherein determining the wireless device location comprises using a global positioning system (GPS).

5. The method of claim 3, wherein determining the wireless device location comprises using an assisted global positioning system (A-GPS).

6. The method of claim 3, wherein determining the wireless device location comprises using a cellular positioning (Cell ID).

7. The method of claim 1, wherein the location request is a session initiation protocol (SIP) request.

8. The method of claim 1, wherein the location response is a session initiation protocol (SIP) response.

9. The method of claim 1, wherein transmitting the location response comprises adding a geolocation-routing header to the location response.

10. The method of claim 7, wherein the location response is in a presence information data format – location object (PIDF-LO) format.

11. A system, the system comprising:
a wireless network;
a computing device communicatively connected to the wireless network, wherein the computing device comprises at least one processor configured to:
transmit a text message to a public safety answering point (PSAP) using the wireless network;
receive a location request from the PSAP using the wireless network; and
in response to receiving the location request, transmit a location response comprising a wireless device location to the PSAP using the wireless network.

12. The system of claim 11, wherein the computing device is further configured to activate a timer after transmitting the text message to allow the location request from the PSAP.

13. The system of claim 11, wherein the computing device is further configured to determine the wireless device location.

14. The system of claim 11, wherein the computing device is further configured to receive the location request and transmit the location response using a session initiation protocol (SIP).

15. The system of claim 14, wherein the computing device is further configured to add a geolocation-routing header to the location response.

16. The system of claim 15, wherein the location response is in a presence information data format – location object (PIDF-LO) format.

17. A non-transitory computer-readable medium storing instructions, when executed by at least one processor, configuring the at least one processor to:
transmit a text message to a public safety answering point (PSAP) using a wireless network;
receive a location request by the PSAP using the wireless network; and
in response to receiving the location request, transmit a location response comprising a wireless device location to the PSAP using the wireless network.

18. The non-transitory computer-readable medium storing instructions of claim 17, wherein the at least one processor is further configured to activate a timer after transmitting the text message to allow the location request from the PSAP.

19. The non-transitory computer-readable medium storing instructions of claim 17, wherein the at least one processor is further configured to determine the wireless device location.

20. The non-transitory computer-readable medium storing instructions of claim 17, wherein the at least one processor is further configured to receive the location request and transmit the location response using a session initiation protocol (SIP).
